(19) United States
(12) Patent Application Publication
(10) Pub. No.: US 2003/0019531 A1
(43) Pub. Date: Jan. 30, 2003

(54) Linear solenoid valve

(76) Inventor: Tomohiro Satoh, Toyoake-shi (JP)

Correspondence Address: Platon N. Mandros, BURNS, DOANE, SWECKER & MATHIS, L.L.P., P.O. BOX 1404, Alexandria, VA, 22313-1404, US

(21) Appl. No.: 10/189,584

(22) Filed: Jul. 8, 2002

(30) Foreign Application Priority Data
Jul. 11, 2001 (JP) 2001-210607

(51) Int. Cl. F15B 13/044

(52) U.S. Cl. 137/625.65

(57) ABSTRACT

A linear solenoid valve provided in a hydraulic pressure control device includes a cylinder having a inlet port communicating with the controlled element and a drain port communicating with a drain, a permanent magnet having a first magnetic pole and a second magnetic pole surrounding the first magnetic pole, a wound movable coil located between the first magnetic pole and the second magnetic pole and movable to the axial direction of the permanent magnet, a valve body disposed with respect to the movable coil to selectively permit and prevent communication between the inlet port and drain port to control communication between the controlled element and the drain. The hydraulic pressure applied to the controlled element is controlled based on an electromagnetic force of the movable coil resulting from electric current applied to the movable coil and a magnetic field generated between the first magnetic pole and the second magnetic pole.

### CROSS REFERENCE TO RELATED APPLICATIONS

This application is based on and claims priority under 35 U.S.C. § 119 with respect to a Japanese Patent Application 2001-210607, filed on Jul. 11, 2001, the entire content of which is incorporated herein by reference.

### FIELD OF THE INVENTION

This invention generally relates to a linear solenoid valve for controlling hydraulic pressure in a controlled element linearly based on electric current to a coil.

### BACKGROUND OF THE INVENTION

A known linear solenoid valve 200 is shown in FIG. 8. The linear solenoid valve 200 is structured from a spool valve and a solenoid. The spool valve has a cylinder 221 and a valve body 222. The cylinder 221 has an inlet port 221a which supplies hydraulic pressure, an outlet port 221b which outputs hydraulic pressure to a controlled element, and a drain port 221c which drains hydraulic pressure. The valve body 222 is disposed in the cylinder 221 for being able to move to axial direction. And the valve body 222 has a land portion 222a which diameter is almost same as bore diameter of the cylinder 221. The solenoid has a movable core 225 mode from magnetic material, a bobbin 224 formed on outer surface of the movable core 225, a coil 224a wound on outer surface of the bobbin 224, and a fixed core 226 fixed to the bobbin 224 and mode from magnetic material. The movable core 225 is moved toward the fixed core 226 by magnetic force generated between the movable core 225 and the fixed core 226 by applying electric current to the coil 224a. And hydraulic pressure into the controlled element is controlled based on the magnetic force.

According to the solenoid valve 200 described above, hydraulic pressure in the controlled element can be controlled to a requested value by controlling the magnetic force between the movable core 225 and the fixed core 226.

However, the above described linear solenoid valve 200, it is difficult to lengthen a clearance between the movable core 225 and the fixed core 226 since moving force of the movable core 225 is the magnetic force between the movable core 225 and the fixed core 226. So it is difficult to lengthen stroke of the valve body 222. Furthermore, it is difficult to enlarge the magnetic force itself since the electric current applying to the coil 224a becomes enlarge. Accordingly, hydraulic pressure being outputted from this type of linear solenoid valve 200 to the controlled element is limited.

Consequently, in case the hydraulic pressure in the controlled element becomes to exceed the threshold value, construction is considered as follows. For instance, in case controlling the hydraulic pressure to the controlled element from the conventional linear solenoid valve so as to change the shift stage of an automatic transmission, the line pressure in a hydraulic pressure circuit of the automatic transmission is reduced by a modulator valve. And the reduced hydraulic pressure is supplied to the linear solenoid valve. The hydraulic pressure outputted from the linear solenoid valve is amplified to a desired value by a control valve. In this way, in case the controlled hydraulic pressure exceeds the threshold value of the linear solenoid valve, it is necessary to set up the modulator valve and the control valve extra. The device for controlling the hydraulic pressure to the automatic transmission enlarges by using the extra valves (the modulator valve and the control valve). Further, responsibility of the hydraulic pressure outputted to the controlled element is deteriorated by increasing the extra valves.

It is an object of this invention to increase the hydraulic pressure outputted from the linear solenoid valve to the controlled element as much as possible without extra valves.

### SUMMARY OF THE INVENTION

A linear solenoid valve provided in a hydraulic pressure control device, which includes a hydraulic pressure source generating hydraulic pressure and a controlled element, to control the hydraulic pressure delivered to the controlled element, includes a cylinder, a permanent magnet, a movable coil, and a valve body. The cylinder having at least two ports, including a first port communicating with the controlled element, and a second port communicating with a drain. The permanent magnet having a first magnetic pole extending in an axial direction of the cylinder and a second magnetic pole surrounding the first magnetic pole, the first and the second magnetic poles having opposite polarities. The wound movable coil located between the first magnetic pole and the second magnetic pole and movable to the axial direction of the permanent magnet. The valve body disposed with respect to the movable coil to selectively permit and prevent communication between the first and second ports to control communication between the controlled element and the drain, And the hydraulic pressure applied to the controlled element is controlled based on an electromagnetic force of the movable coil resulting from electric current applied to the movable coil and a magnetic field generated between the first magnetic pole and the second magnetic pole.

According to the claim 1, an electromagnetic force is generated to the movable coil in the perpendicular direction with respect to the electric current and the magnetic field when the electric current is turned to the movable coil. In fact, the electromagnetic force is generated with respect to an axial length of the movable coil which crossing with the magnetic field. Accordingly, a constant electromagnetic force is affected to the movable coil without reference to influence of the axial stroke of the movable coil. So the constant electromagnetic force is assured by lengthening the axial stroke of the movable coil. Outputting quantity of the hydraulic pressure can be increased when the first port and the second port communicates by lengthening the axial stroke of the movable coil. In this way, the hydraulic pressure in the controlled element can be increased as much as possible without extra valves.

Further, according to the claim 1, direction of the electromagnetic force generated to the movable coil can be switched by switching the direction of the electric current applied to the movable coil. The valve body can be moved to two opposite axial direction actively with respect to the direction of the electromagnetic force. Accordingly, operating responsibility of the valve body can be improved by switching the direction of the electric current applied to the movable coil.

And according to the claim 1, an electromotive force is generated in the movable coil since the valve body moves to the axial direction by the fluctuation of the hydraulic pressure in the controlled element. So the electric current turning in the movable coil fluctuates corresponding to the axial fluctuation of the valve body. Hence, realizing a vibrating phenomenon in the controlled element, and turning the electric current to the movable coil so as to move the valve body to the axial direction to restrain the vibrating phenomenon actively, the fluctuation of the hydraulic pressure and the vibration of the valve body can be restrained.

### BRIEF DESCRIPTION OF THE DRAWING FIGURES

The foregoing and additional features and characteristics of the present invention will become more apparent from the following detailed description considered with reference to the accompanying drawing figures wherein:

FIG. 1 is a block diagram of an automatic transmission system;

FIG. 2 is a skeleton diagram of the automatic transmission illustrated in FIG. 1;

FIG. 3 is a schematic view illustrating a control pressure control system including a linear solenoid valve according to a first embodiment of the present invention;

FIG. 4 is a schematic view illustrating a valve body of the linear solenoid valve is in a second position according to an embodiment of the present invention;

FIG. 5 is a schematic view illustrating the valve body is in a third position according to an embodiment of the present invention;

FIG. 6 is a enlarged view of the linear solenoid valve shown in FIGS. 3 to 5 and 7;

FIG. 7 is a schematic view illustrating a control pressure control system including a linear solenoid valve according to a second embodiment of the present invention;

FIG. 8 is a schematic view illustrating a linear solenoid valve of a prior art.

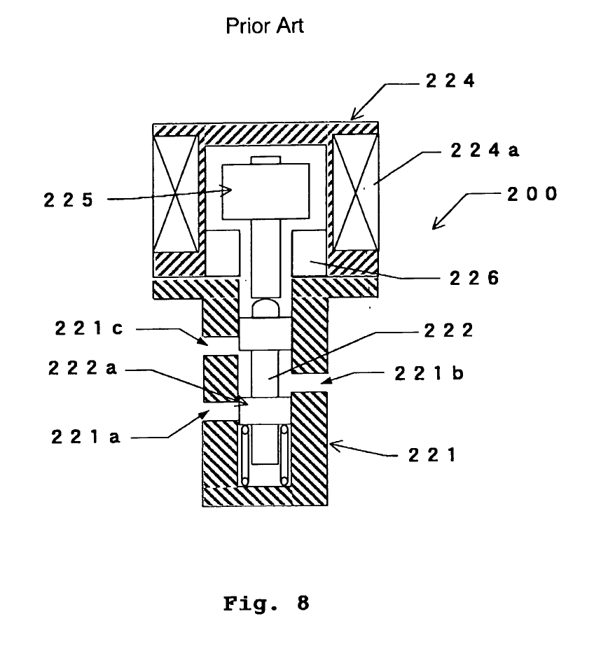

### DETAILED DESCRIPTION OF THE PRESENT INVENTION

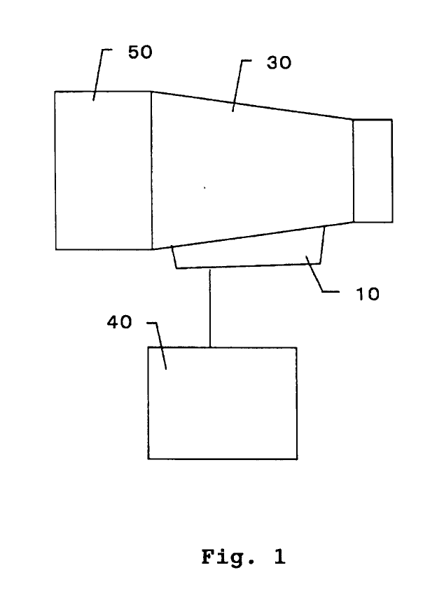

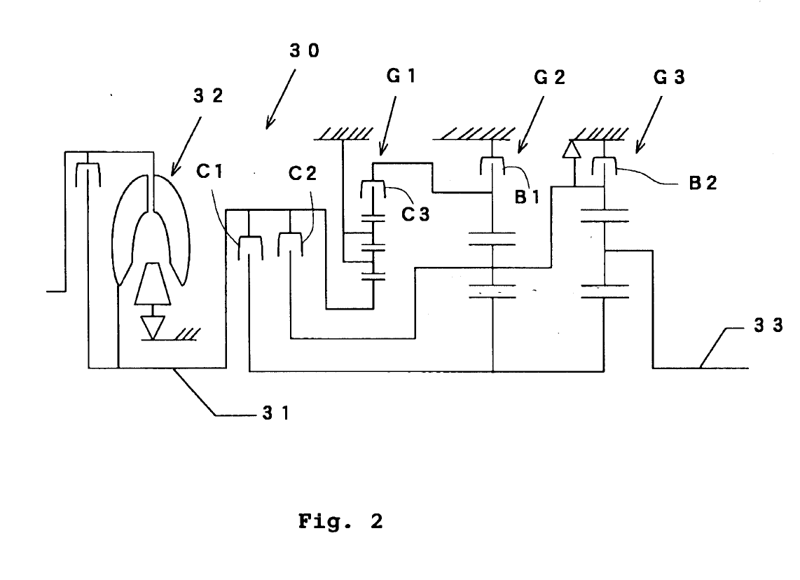

First of all, with reference to FIG. 1, an automatic transmission system is made up of an automatic transmission 30 which is connected to an output shaft (not shown) of an engine 50, a pressure control mechanism 10, an electronic control portion 40. The automatic transmission 30 has a kinetic arrangement shown in FIG. 2 which will be detailed later. Such an arrangement includes five frictional engaging elements (controlled elements): B1, B2, C1, C2, and C3. The pressure control mechanism 10 is incorporated in the automatic transmission 30 for establishing supply and drain of oil pressure (hydraulic pressure) to and from, respectively, each of the frictional engaging elements B1, B2, C1, C2, and C3. The electronic control portion 40 is used for controlling plural solenoid valves in the pressure control mechanism 10. A plurality of linear solenoid valves are built in the pressure control mechanism 10 so as to control the oil pressure in the frictional engaging elements: B1, B2, C1, C2, and C3.

As can be seen from FIG. 2, the automatic transmission 30 includes an input shaft 31 as an output shaft of a torque converter 32, an output shaft 33 connected to each of wheel axles (not shown) by way of a differential (not shown), a double pinion planetary gear unit G1, a first single pinion planetary gear unit G2, and a second single pinion planetary gear unit G3 in addition to the aforementioned frictional engaging elements B1, B2, C1, C2, and C3. The automatic transmission 30 is designed to produce six forward and one reverse gear stages by the oil control of each of the adjusting the oil control pressure of each of the frictional engaging elements which is established by the pressure control mechanism 10 and the electronic control portion 40.

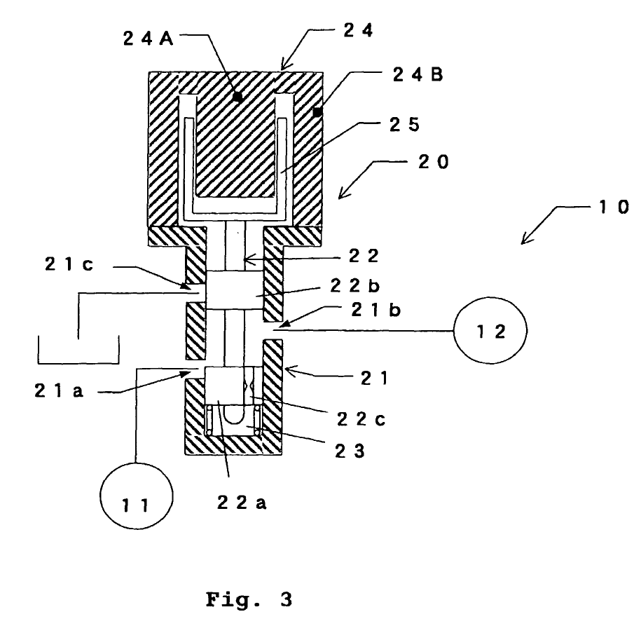

FIGS. 3 to 6 shows a first embodiment of a linear solenoid valve 20. The linear solenoid valve 20 is used to control the oil pressure in one of the friction engaging elements for changing the shift stage of an automatic transmission.

As shown in FIG. 1, the pressure control mechanism 10 includes a oil pump 11 (hydraulic pressure source) for generating oil pressure, a linear solenoid valve 20 for inputting the oil pressure from the oil pump 11 and outputting a oil pressure with respect to the electric current applied thereto, a frictional engaging element 12 for being supplied the oil pressure outputted from the linear solenoid valve 20. Applying the electric current to the linear solenoid valve 20 is controlled by a control circuit (not shown). The frictional engaging element 12 is a multiplate wet clutch being engaged by pressure force of a piston based on the supplied oil pressure.

FIG. 3 shows one linear solenoid valve 20 and one frictional engaging element 12. However, it needs to control the oil pressure to plurals frictional engaging elements (not shown) for changing the shift stage. Therefore, the pressure control mechanism 10 has a plurality of linear solenoid valves and frictional engaging elements as shown in FIG. 3. Furthermore, it is possible to constitute the pressure control mechanism 10 for providing the oil pressure outputted from linear solenoid valve 20 to a plurality of frictional engaging elements and outputting the hydraulic pressure to one of the frictional engaging element by shifting of a shift valve which operates based on a ON-OFF solenoid. In this constitution, number of controlled frictional engaging elements increase without increasing number of the expensive linear solenoid valve. So it is desirable from cost and controllability.

The linear solenoid valve 20 includes a cylinder 21, a permanent magnet 24 fixed to one end of the cylinder 21, a wound movable coil 25 formed at one end of the cylinder 21 and a valve body 22. The cylinder 21 has an inlet port 21a for receiving the oil pressure from the oil pump 11, an outlet port 21b for outputting the oil pressure from oil pump 11 to the frictional engaging element 12, and a drain port 21c for draining the oil pressure. The permanent magnet 24 has a first magnetic pole 24A extending in an axial direction of the cylinder 21 and a second magnetic pole 24B surrounding the first magnetic pole 24A, the first and the second magnetic poles 24A, 24B have opposite polarities. The first magnetic pole 24A is solid cylindrical shaped, and the second magnetic pole 24B is hollow cylindrical shaped. The movable coil 25 located between the first magnetic pole 24A and the second magnetic pole 24B and movable to the axial direction of the permanent magnet 24. The valve body 22 is disposed with respect to the movable coil 25 to selectively permit and prevent communication between the each port. In this embodiment, the first magnetic pole 24A is North pole, the second magnetic pole 24B is South pole.

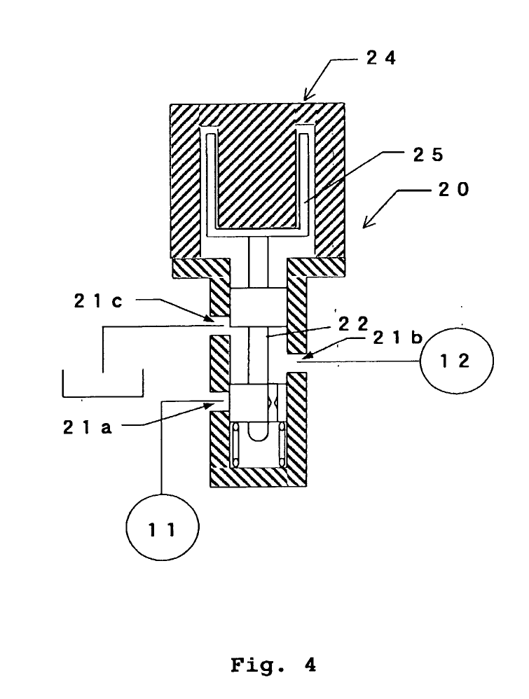

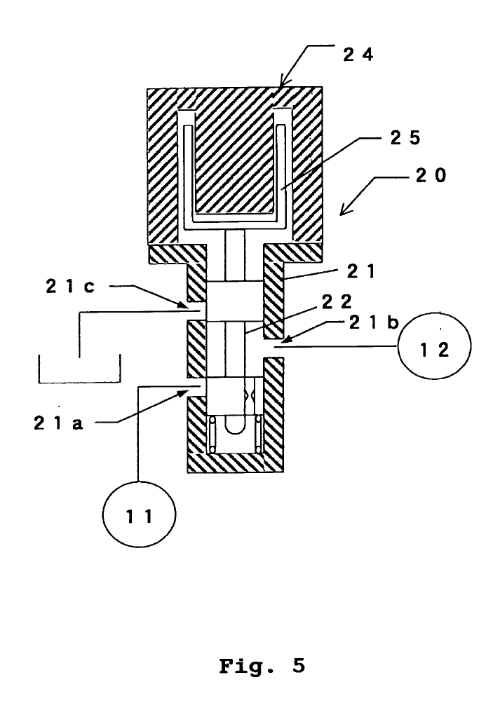

The inlet port 21a, the outlet port 21b and the drain port 21c are formed on outer circumferential surface of the cylinder 21. The valve body 22 includes a first land 22a and a second land 22b. Outer diameter of these lands 22a, 22b are substantially same of inner diameter of the cylinder 21, and these lands 22a, 22b are in sliding contact with the inner surface of the cylinder 21. Axial position of the valve body 22 against the each lands 22a, 22b is changed between a first position, a second position and a third position. In the first position, communication between the inlet port 21a and the outlet port 21 is permitted and communication between the drain port 21c and the outlet port 21b is prevented. In the second position, communication between the drain port 21c and the outlet port 21b is permitted and communication between the inlet port 21a and the outlet port 21 is prevented. The third position, communication between the inlet port 21a and the outlet port 21b, communication between the drain port 21c and the outlet port 21b are prevented. FIG. 3 shows the valve body 22 is in the first position. FIG. 4 shows the valve body 22 is in the second position. FIG. 5 shows the valve body 22 is in the third position. In this embodiment, the first land 22a corresponds to a land in claims.

A hydraulic chamber 23 is formed between an inner surface of the other end of the cylinder 21 and the first land 22a. The hydraulic chamber 23 communicates with the space between the first land 22a and the second land 22b by an orifice 22c. The space between the first land 22a and the second land 22b communicates with the frictional engaging element 12 via the outlet port 21b. Accordingly, the oil pressure in the space between the first land 22a and the second land 22b, the oil pressure in the hydraulic chamber 23, and the oil pressure in the frictional engaging element 12 become same value by feeding back the oil pressure in the frictional engaging element 12 into the hydraulic chamber 23.

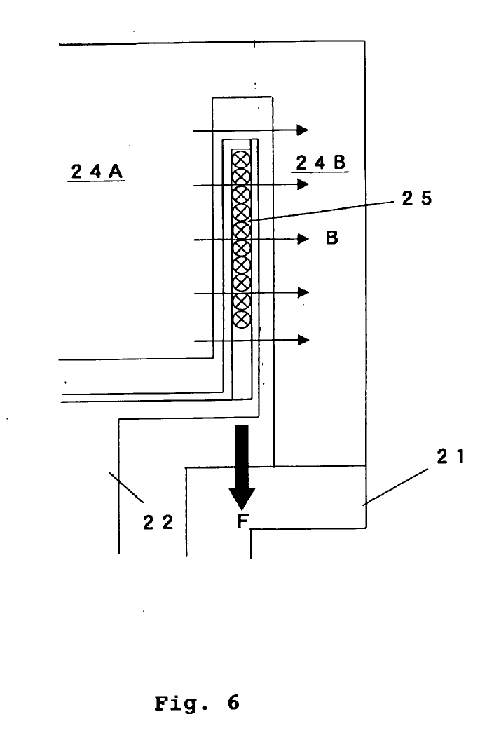

FIG. 6 is an enlarged view of the permanent magnet 24 and the movable coil 25 of the linear solenoid valve 20. In FIG. 6, electric current in the movable coil 25 flows perpendicularly from the front surface of the paper that FIG. 6 is shown. In this embodiment, the movable coil 25 is wound within an axial length of the first magnetic pole 24A and the second magnetic pole 24B. So the electric current I passing through the magnetic field B generated from the first magnetic pole 24A to the second magnetic pole 24B maintains constant value, even though the movable coil 25 moves axial direction. Accordingly, electromagnetic force of the movable coil 25 resulting from electric current applied to the movable coil 25 and a magnetic field B despite of the axial position of the movable coil 25.

The operation of the linear solenoid valve 20 is described below. The shift stage of the automatic transmission is determined by opening degree of a throttle valve (not shown) and vehicle velocity. The shift stage is shifted by changing the frictional engaging element 12 from engaging condition to disengaging condition or changing the frictional engaging element 12 from disengaging condition to engaging condition. At first, shifting to the engaging condition of the frictional engaging element 12 from the disengaging condition is described. The electric current in the movable coil 25 flows opposite direction in the direction shown in FIG. 6 when the disengaging condition of the frictional engaging element 12 before shifting. In this condition, the electromagnetic force of the movable coil 25 resulting from the magnetic field B and the electric current I flowing in the movable coil 25, and direction of the electromagnetic force is opposite in the direction shown in FIG. 6. The valve body 22 positions at the second position shown in FIG. 4 by moving upper side in FIG. 6 rapidly based on the movement of the movable coil 25. The electromagnetic force F toward the upper side in FIG. 6 is in proportion to the product with the magnetic field B and the electric current I. The electromagnetic force F is in proportion to the electric current I since the magnetic field B does not change. The oil pressure in the frictional engaging element 12 is almost same as the pressure in the atmosphere since the oil in the frictional engaging element 12 is outputted from the drain port 21c when the valve body 22 is in the second position. Accordingly, the frictional engaging element 12 disengages.

The movable coil 25 is applied the electric current in the direction to show in FIG. 6 immediately after the shifting from disengaging condition to the engaging condition of the frictional engaging element 12. And the electromagnetic force F of the movable coil 25 toward the lower side in the FIG. 6 resulting from the magnetic field B and electric current I. The valve body 22 positions at the first position shown in FIG. 3 by moving lower side in FIG. 6 based on the movement of the movable coil 25. In this condition, a line pressure is provided from the inlet port 21a, and the oil pressure is supplied to the frictional engaging element 12 via the outlet port 21b. In case the valve body 22 keeps positioning at the first position and continues supplying the oil pressure, the oil pressure in the frictional engaging element 12 and hydraulic chamber 23 becomes gradually large. When the pressure force in the hydraulic chamber 23 is larger than the electromagnetic force F, the valve body 22 moves toward upper side in FIG. 6. So the position of the valve body 22 returns to the second position, and the oil pressure in the frictional engaging element 12 is drained. The pressure force in the hydraulic chamber 23 becomes small by draining the oil pressure in the frictional engaging element 12, and the electromagnetic force F of the movable coil 25 becomes larger than the pressure force in the hydraulic chamber 23. And the valve body 22 positions at the first position again. The pressure force in the frictional engaging element 12 gradually approaches to the electromagnetic force F by the position of the valve body 22 changes repeatedly between the first position and the second position. The valve body 22 maintains the third position shown in the FIG. 5 when the pressure force in the frictional engaging element 12 balances with the electromagnetic force F. In this way, the oil pressure in the frictional engaging element 12 is controlled based on the electromagnetic force F of the movable coil 25 which is in proportion to the electric current I flowing in the movable coil 25. Namely, engaging force of the frictional engaging element 12 is controlled by the electric current I flowing in the movable coil 25.

Next, shifting to the disengaging condition of the frictional engaging element 12 from the engaging condition is described. The electric current in the movable coil 25 flows in the direction shown in FIG. 6 when the frictional engaging element 12 is engaging condition before shifting. In this condition, the electromagnetic force F of the movable coil 25 being in proportion with the electric current I flowing in the movable coil 25 balances with the pressure force in the frictional engaging element 12. And the position of the valve body 22 keeps positioning at the third position.

The movable coil 25 is applied the electric current in the opposite direction to show in FIG. 6 immediately after the shifting from engaging condition to the disengaging condition of the frictional engaging element 12. And the electromagnetic force F of the movable coil 25 toward the opposite direction showed in the FIG. 6 resulting from the magnetic field B and electric current I. The valve body 22 positions at the second position shown in FIG. 4 by moving upper side in FIG. 6 based on the movement of the movable coil 25. The oil pressure in the frictional engaging element 12 is almost same as the pressure in the atmosphere since the oil in the frictional engaging element 12 is outputted from the drain port 21c. Accordingly, the frictional engaging element 12 disengages.

According to this embodiment, a coil spring is disposed between the first land 22a and the other end of the cylinder 21 so as to urge the valve body 22 toward the upper side in FIG. 3. The coil spring does not function efficiency under the normal operation of the movable coil 25 in case draining the oil pressure from the frictional engaging element 12. However, in case the electric current does not flow in the movable coil 25 by abnormal condition of the pressure control mechanism 10, the valve body 22 is certainly positioned at the second position by urging force of the coil spring. Namely, the coil spring functions as fail safe device.

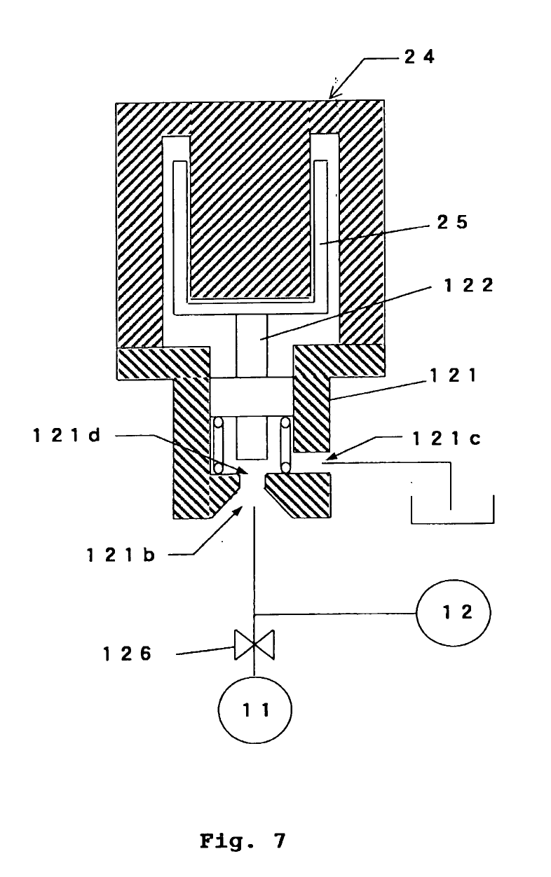

FIG. 7 shows a control pressure control system including a linear solenoid valve 120 according to a second embodiment of this invention.

In the second embodiment, structures of a cylinder 121 and a valve body 122 are different from the first embodiment. However, another compositions (permanent magnet 24, movable coil 25, oil pump 11, frictional engaging element 12, and so on) are same as the first embodiment, so the signs of these compositions are same as the first embodiment and omitted the explanations.

The cylinder 121 forms a drain port 121c on outer circumferential surface of the cylinder 121, an outlet port 121b on axial end of the cylinder 121, and a communication port 121d communicating between the drain port 121c and the outlet port 121b. The valve body 122 fixed to the movable coils 25 permits or prevents communication between the outlet port 121b and the drain port 121c by the end portion contacting or leaving from the communication port 121d. The oil pressure from the oil pump 11 is always provided to the outlet port 121b when the oil pump is operating despite of the axial position of the valve body 122.

The operation of the linear solenoid valve 120 is described below. The operation is explained by using FIG. 6 since the structures of the permanent magnet 24 and the movable coil 25 are same as the first embodiment. At first, shifting to the engaging condition of the frictional engaging element 12 from the disengaging condition is described. The electric current in the movable coil 25 flows opposite direction in the direction shown in FIG. 6 when the disengaging condition of the frictional engaging element 12 before shifting. In this condition, the electromagnetic force F of the movable coil 25 resulting from the magnetic field B and the electric current I flowing in the movable coil 25. Direction of the electromagnetic force F is opposite in the direction shown in FIG. 6. The valve body 22 positions at the position shown in FIG. 7 by moving upper side in FIG. 6 rapidly based on the movement of the movable coil 25. When the valve body 22 is in the position shown in FIG. 7, the oil pressure in the frictional engaging element 12 is almost same as the pressure in the atmosphere since the oil pressure supplied from the outlet port 121b is drained through the communication port 121d and the drain port 121c. Accordingly, the frictional engaging element 12 disengages.

The movable coil 25 is applied the electric current in the direction to show in FIG. 6 immediately after the shifting from disengaging condition to the engaging condition of the frictional engaging element 12. And the electromagnetic force F of the movable coil 25 toward the lower side in the FIG. 6 resulting from the magnetic field B and electric current I. The valve body 122 moves toward lower side in FIG. 6 based on the movement of the movable coil 25. In this condition, the end of the valve body 122 contacts with the communication port 121d, and communication of the oil pressure between the outlet port 121b and the drain port 121c is prevented. Therefore, the oil pressure is provided to the frictional engaging element 12 since the line pressure from the oil pump 11 does not drain. In case the end of the valve body 122 keeps contacting with the communication port 121d, the oil pressure is supplied to the frictional engaging element 12 continuously, the oil pressure in the frictional engaging element 12 becomes gradually large. When the pressure force in the frictional engaging element 12 is larger than the electromagnetic force F, the valve body 122 moves toward upper side in FIG. 6. And the end of the valve body 122 leaves from the communication port 121d, the oil pressure in the frictional engaging element 12 is drained from the drain port 121c.

The pressure force in the frictional engaging element 12 becomes small by draining the oil pressure, and the electromagnetic force F of the movable coil 25 becomes larger than the pressure force in the frictional engaging element 12. And the valve body 122 positions at the upper side in FIG. 6 again, communication by the communication port 121d is prevented. The pressure force in the frictional engaging element 12 gradually approaches to the electromagnetic force F by the end of the valve body 122 contacting and leaving from the communication port 121d repeatedly. In this way, the oil pressure in the frictional engaging element 12 is controlled based on the electromagnetic force F of the movable coil 25 which is in proportion to the electric current I flowing in the movable coil 25. Namely, engaging force of the frictional engaging element 12 is controlled by the electric current I flowing in the movable coil 25.

Next, shifting to the disengaging condition of the frictional engaging element 12 from the engaging condition is described. The movable coil 25 is applied the electric current in the opposite direction to show in FIG. 6 immediately after the shifting from engaging condition to the disengaging condition of the frictional engaging element 12. And the electromagnetic force F toward the upper side in the FIG. 6 resulting from the magnetic field B and electric current I. The valve body 122 moves toward upper side in FIG. 6 based on the movement of the movable coil 25. Therefore, the end of the valve body 122 leaves from the communication port 121d. The oil pressure in the frictional engaging element 12 is almost same as the pressure in the atmosphere since the oil in the frictional engaging element 12 is outputted from the drain port 121c. Accordingly, the frictional engaging element 12 disengages.

As explained, according to the linear solenoid valves 20 and 120, the movable coil 25 crossing with the magnetic field B is generated the electromagnetic force when the electric current is applied to the movable coil 25. Accordingly, the stable electromagnetic force is gained despite of the axial stroke of the movable coil 25. In this way, it is possible to set large axial stroke of the valve body with keeping the stable electromagnetic force. Applying quantity of the oil pressure to the frictional engaging element 12 becomes large by the axial stroke of the valve body becomes large. Therefore, controlled oil pressure in the frictional engaging element 12 can be enlarged.

According to these embodiments, the valve bodies 22, 122 are moved toward two axial directions actively by changing the direction of the electric current flowing in the movable coil 25. Herewith, the valve bodies 22, 122 are moved toward another two axial directions quickly, operational responsibilities of the valve bodies 22, 122 improve. And the oil pressure in the frictional engaging element 12 can be controlled quickly.

According to these embodiments, in case the valve bodies 22, 122 are moved by fluctuation of the oil pressure in the frictional engaging element 12, an electromotive force is resulting from the magnetic field B and the vibration of the valve body. With the result that, the electric current flowing in the movable coil 25 fluctuates accompanying with the vibration of the valve body. Accordingly, the fluctuation of the oil pressure and the vibration of the valve body can be prevented by applying the electric current to the movable coil 25 for moving the valve body toward the opposite direction against the vibration of the valve body.

According to this invention, the hydraulic pressure in the frictional engaging element can be controlled at pleasure without using the modulator valve or the control valve described at background in the invention.

The invention has thus been shown and description with reference to specific embodiments, however, it should be understood that the invention is in no way limited to the details of the illustrates structures but changes and modifications may be made without departing from the scope of the appended claims. For example, a concept can be employed in case there is a shift valve for shifting the controlled frictional engaging element between the linear solenoid valve and a plurality of frictional engaging element.

What we claim is:

1. A linear solenoid valve provided in a hydraulic pressure control device, which includes a hydraulic pressure, source generating hydraulic pressure and a controlled element, to control the, hydraulic pressure delivered to the controlled element, comprising;
a cylinder having at least two ports, including a first port communicating with the controlled element, and a second port communicating with a drain;
a permanent magnet having a first-magnetic pole extending in an axial direction of the cylinder and a second magnetic pole surrounding the first magnetic pole, the first and the second magnetic poles having opposite polarities;
a wound movable coil located between the first magnetic pole and the second magnetic pole and movable to the axial direction of the permanent magnet;
a valve body disposed with respect to the movable coil to selectively permit and prevent communication between the first and second ports to control communication between the controlled element and the drain;
wherein the hydraulic pressure applied to the controlled element is controlled based on an electromagnetic force of the movable coil resulting from electric current applied to the movable coil and a magnetic field generated between the first magnetic pole and the second magnetic pole.

2. A linear solenoid valve according to claim 1, wherein the first port is an outlet port for outputting the hydraulic pressure to the controlled element, the second port is a drain port for draining the hydraulic pressure to the drain, and including an inlet port for receiving the hydraulic pressure from the hydraulic pressure source.

3. A linear solenoid valve according to claim 1, wherein the controlled element is positioned between the first port and the hydraulic pressure source.

4. A linear solenoid valve for controlling hydraulic pressure to a controlled element comprising:
cylinder having an inlet port for receiving the hydraulic pressure from a hydraulic pressure source, an outlet port for outputting the hydraulic pressure to the controlled element, and a drain port for draining the hydraulic pressure;
a permanent magnet having a first magnetic pole extending in an axial direction of the cylinder and a second magnetic pole surrounding the first magnetic pole, the first and the second magnetic poles having opposite polarities;
a wound movable coil located between the first magnetic pole and the second magnetic pole and movable to the axial direction of the permanent magnet;
a valve body operatively disposed with respect to the movable coil to by moved by the movable coil to selectively permit and prevent communication between the inlet port and the outlet port corresponding to the axial movement of the movable coil with respect to the permanent magnet, and to selectively permit and prevent communication between the outlet port and the drain port corresponding to the axial movement of the movable coil with respect to the permanent magnet;
wherein the hydraulic pressure applied to the controlled element is controlled based on an electromagnetic force of the movable coil resulting from electric current applied to the movable coil and a magnetic field generated between the first magnetic pole and the second magnetic pole.

5. A linear solenoid valve according to claim 4, wherein the valve body is disposed inside of the cylinder so as to move to axial direction and has a land which outer diameter is as almost same as the inner diameter of the cylinder,
axial position of the valve body is changeable between a first position which communicates the inlet port and the outlet port and cuts off the drain port and the outlet port by the land, a second position which communicates the drain port and the outlet port and cuts off the inlet port and the outlet port by the land, and a third position which cuts off the inlet port and the drain port with the outlet port by the land.

6. A linear solenoid valve according to claim 5, wherein the hydraulic pressure in the controlled element is fed back to a chamber formed between an inner surface of the other end of the cylinder and the land.

7. A linear solenoid valve according to claim 6, wherein the valve body moves to the first position when the hydraulic pressure in the chamber is smaller than the electromagnetic force of the movable coil opposites to the hydraulic pressure in the chamber, the valve body moves to the second position when the hydraulic pressure in the chamber is larger than the electromagnetic force of the movable coil, the valve body moves to the third position when the hydraulic pressure in the chamber balances with the electromagnetic force of the movable coil.

8. A linear solenoid valve according to claim 7, wherein the controlled element is a frictional engaging element for changing the shift stage of an automatic transmission, and engagement or disengagement of the frictional engaging element is controlled corresponding to the hydraulic pressure in the frictional engaging element.

9. A linear solenoid valve for controlling hydraulic pressure to a controlled element comprising:
a cylinder having a communication port for being connected to a pressure source which generates the hydraulic pressure and a drain port for draining the hydraulic pressure from the hydraulic pressure source;
a permanent magnet having a first magnetic pole extending in an axial direction of the cylinder, and a second magnetic pole surrounding the first magnetic pole, the first and second magnetic poles having different polarities;
a wound movable coil located between the first magnetic pole and the second magnetic pole and movable in an axial direction of the permanent magnet;
a valve body operatively disposed with respect to the movable coil to be moved by the movable coil to selectively permit land prevent communication between the drain port and the communication port corresponding to the axial movement of the movable coil with respect to the permanent magnet;
wherein the hydraulic pressure applied to the controlled element is controlled based on an electromagnetic force of the movable coil resulting from electric current applied to the movable coil and a magnetic field generated between the first magnetic pole and the second magnetic pole.

10. A linear solenoid valve according to claim 9, wherein the communication port is formed so as to be opposed to the end of the valve body, and communication between the drain port and the communication port is prevented when the end of the valve body contact with the communication port.

11. A linear solenoid valve according to claim 10, wherein the controlled element is a frictional engaging element for changing the shift stage of an automatic transmission, and engagement or disengagement of the frictional engaging element is controlled corresponding to the hydraulic pressure in the frictional engaging element.

12. A linear solenoid valve according to claim 10, wherein the controlled element is positioned between the communication port and the hydraulic pressure source.
